(19) United States
(12) Patent Application Publication
(10) Pub. No.: US 2025/0166868 A1
(43) Pub. Date: May 22, 2025

(54) SHIELD CABLE

(71) Applicant: Proterial, Ltd., Tokyo (JP)

(72) Inventors: Hirotaka ESHIMA, Tokyo (JP); Yoshikazu HAYAKAWA, Tokyo (JP); Tomoyuki MURAYAMA, Tokyo (JP); Takahiro FUTATSUMORI, Tokyo (JP)

(21) Appl. No.: 18/957,034

(22) Filed: Nov. 22, 2024

(30) Foreign Application Priority Data
Nov. 22, 2023 (JP) 2023-198261

(51) Int. Cl. H01B 7/18

(52) U.S. Cl. CPC H01B 7/1875; H01B 7/1855

(57) ABSTRACT

Provided herein is a shield cable that can inhibit a shield from being damaged when the shield cable is bent. The shield cable of the present disclosure includes a central conductor; an insulator situated closer to an outer circumference of the shield cable than the central conductor is; a first tape layer situated closer to the outer circumference of the shield cable than the insulator is, and made of a paper, a non-woven fabric, or a resin tape; a shield situated closer to the outer circumference of the shield cable than the first tape layer is; a second tape layer situated closer to the outer circumference of the shield cable than the shield is, and including a paper, a non-woven fabric, or a resin tape; and a sheath situated closer to the outer circumference of the shield cable than the second tape layer is.

### CROSS-REFERENCE TO RELATED APPLICATIONS

This application claims the benefit of Japanese Patent Application No. 2023-198261 filed on Nov. 22, 2023 with the Japan Patent Office, the entire disclosure of which is incorporated herein by reference.

### BACKGROUND

The present disclosure relates to a shield cable.

Japanese Unexamined Patent Application Publication No. 2018-65545 discloses a shield cable. The shield cable is, for example, a cable for an IWM (in-wheel motor). The shield cable includes a central conductor, an insulator, a shield, and a sheath. The insulator is situated closer to the outer circumference of the shield cable than the central conductor is. The shield is situated closer to the outer circumference of the shield cable than the insulator is. The sheath is situated closer to the outer circumference of the shield cable than the shield is.

### SUMMARY

The shield may sometimes be damaged when the shield cable is bent. In one aspect of the present disclosure, it is preferable to provide a shield cable that can inhibit a shield from being damaged when the shield cable is bent.

One aspect of the present disclosure is a shield cable that includes a central conductor; an insulator situated closer to an outer circumference of the shield cable than the central conductor is; a first tape layer situated closer to the outer circumference of the shield cable than the insulator is, and made of a paper, a non-woven fabric, or a resin tape; a shield situated closer to the outer circumference of the shield cable than the first tape layer is; a second tape layer situated closer to the outer circumference of the shield cable than the shield is, and including a paper, a non-woven fabric, or a resin tape; and a sheath situated closer to the outer circumference of the shield cable than the second tape layer is.

The shield cable, which is one aspect of the present disclosure, can inhibit the shield from being damaged when the shield cable is bent.

Another aspect of the present disclosure is a shield cable including electric wires twisted together; a first tape layer situated closer to an outer circumference of the shield cable than the electric wires are, and including a paper, a non-woven fabric, or a resin tape; a shield situated closer to the outer circumference of the shield cable than the first tape layer is; a second tape layer situated closer to the outer circumference of the shield cable than the shield is, and including a paper, a non-woven fabric, or a resin tape; and a sheath situated closer to the outer circumference of the shield cable than the second tape layer is.

The shield cable, which is another aspect of the present disclosure, can inhibit the shield from being damaged when the shield cable is bent.

### BRIEF DESCRIPTION OF THE DRAWINGS

Example embodiments of the present disclosure will be described hereinafter with reference to the accompanying drawings, in which:

FIG. 1 is a plan view showing a configuration of a shield cable;

FIG. 2 is a cross sectional view taken along arrows II-II in FIG. 1; and

FIG. 3 is a cross sectional view showing an orthogonal cross section of a shield cable of a second embodiment.

### DETAILED DESCRIPTION OF EXEMPLARY EMBODIMENTS

### First Embodiment

### 1. Configuration of Shield Cable 1

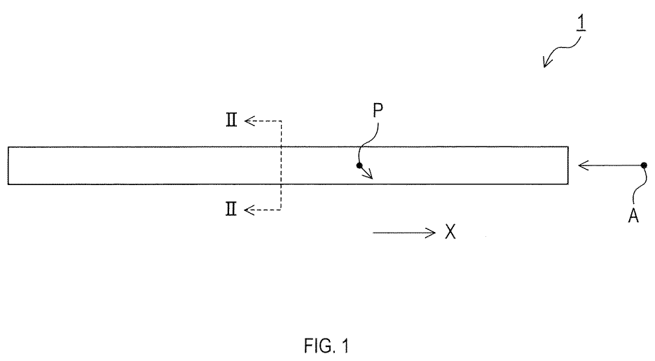

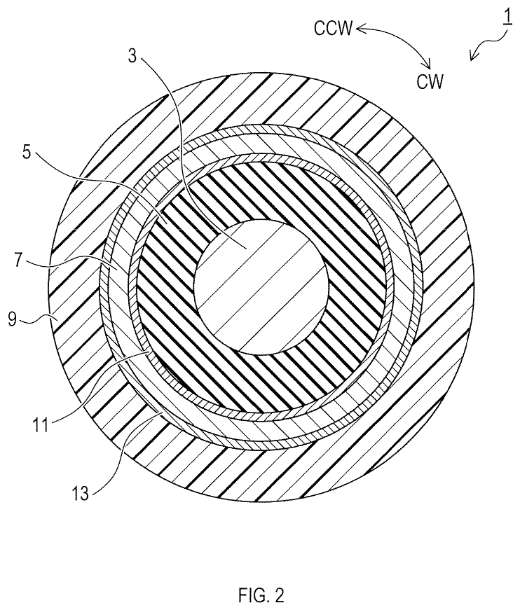

Configuration of a shield cable 1 will be explained with reference to FIG. 1 and FIG. 2. As shown in FIG. 1, the shield cable 1 is a linear member. The shield cable 1 is, for example, a cable for an IWM (in-wheel motor).

As shown in FIG. 2, the shield cable 1 includes a central conductor 3. In a cross section of the shield cable 1 taken orthogonally to longitudinal directions of the shield cable 1 (hereinafter referred to as “orthogonal cross section”), the central conductor 3 is disposed at the center of the shield cable 1. The central conductor 3 includes conductor strands. The conductor strands are made of copper and copper alloy, for example. The conductor strands may be tin-plated soft copper wires.

The conductor strands are twisted together, for example. The twisting direction of the conductor strands is defined as follows. As shown in FIG. 1, a virtual point P is assumed on one of the conductor strands and moved along a longitudinal direction of this conductor strand.

At this time, the point P moves in the direction X of the longitudinal directions of the shield cable 1 as shown in FIG. 1. The point P is observed from a viewpoint A shown in FIG. 1. The viewpoint A is located on a line extending from the shield cable 1 in the direction X. As shown in FIG. 2, the moving direction of the point P as viewed from the viewpoint A is a clockwise direction CW with the center of rotation being the central conductor 3, or a counter clockwise direction CCW with the center of rotation being the central conductor 3. The moving direction of the point P as viewed from the viewpoint A is the twisting direction of the conductor strands.

The central conductor 3 includes two or more bundles of primary-twisted conductor strands, for example. These bundles are then secondary-twisted. The central conductor 3 is not limited to be prepared by secondary-twisting two or more bundles, and may be prepared by twisting a single bundle of the conductor strands.

In these cases, the twisting direction of the conductor strands is defined as follows. A virtual point P is assumed on a bundle of the conductor strands and moved along a longitudinal direction of the bundle.

At this time, the point P moves in the direction X of the longitudinal directions of the shield cable 1 as shown in FIG. 1. The point P is observed from the viewpoint A shown in FIG. 1. As shown in FIG. 2, the moving direction of the point P as viewed from the viewpoint A is the clockwise direction CW with the center of rotation being the central conductor 3, or the counter clockwise direction CCW with the center of rotation being the central conductor 3. The moving direction of the point P as viewed from the viewpoint A is the twisting direction of the conductor strands.

As shown in FIG. 2, the shield cable 1 includes an insulator 5. In the orthogonal cross section, the insulator 5 is situated closer to the outer circumference of the shield cable 1 than the central conductor 3 is. For example, the outer peripheral surface of the central conductor 3 contacts the inner peripheral surface of the insulator 5. For example, the thickness of the insulator 5 is constant at any points in the circumferential direction.

The insulator 5 includes a mixture (hereinafter referred to as “specific mixture”) containing ethylene-propylene rubber and ethylene-methyl acrylate copolymer and prepared by crosslinking the same. For example, the insulator 5 preferably includes no components other than the specific mixture except for inevitable impurities. Meanwhile, the insulator 5 may include a component other than the specific mixture, for example, to an extent that the solution of the problem of the present disclosure is not hindered.

The specific mixture can be produced, for example, by generating a mixture of ethylene-propylene rubber and ethylene-methyl acrylate copolymer, and having this mixture crosslinked.

As shown in FIG. 2, the shield cable 1 includes a shield 7. In the orthogonal cross section, the shield 7 is situated closer to the outer circumference of the shield cable 1 than the insulator 5 is. For example, the thickness of the shield 7 is constant at any points in the circumferential direction. For example, the shield 7 is a braided shield. Examples of the braided shield include a copper foil thread braid, a copper strand braid, and a copper alloy braid. For example, the shield 7 is thinner than the insulator 5.

As shown in FIG. 2, the shield cable 1 includes a sheath 9. In the orthogonal cross section, the sheath 9 is situated closer to the outer circumference of the shield cable 1 than the shield 7 is. In the present embodiment, the inner peripheral surface of the sheath 9 contacts the outer peripheral surface of the shield 7.

For example, the thickness of the sheath 9 is constant at any points in the circumferential direction. For example, the sheath 9 is thicker than the insulator 5. For example, the sheath 9 is thinner than the insulator 5 and thicker than the shield 7.

For example, the sheath 9 includes the specific mixture. In this case, for example, the sheath 9 preferably includes no components other than the specific mixture except for the inevitable impurities. Meanwhile, the sheath 9 may include a component other than the specific mixture, for example, to an extent that the solution of the problem of the present disclosure is not hindered. For example, the specific mixture in the sheath 9 is the same as the specific mixture in the insulator 5.

For example, the sheath 9 may include ethylene propylene diene rubber. In this case, for example, the sheath 9 preferably includes no components other than ethylene propylene diene rubber except for the inevitable impurities. Meanwhile, the sheath 9 may include a component other than ethylene propylene diene rubber, for example, to an extent that the solution of the problem of the present disclosure is not hindered.

For example, the sheath 9 may include thermoplastic urethane. In this case, for example, the sheath 9 preferably includes no components other than thermoplastic urethane except for the inevitable impurities. Meanwhile, the sheath 9 may include a component other than thermoplastic urethane, for example, to an extent that the solution of the problem of the present disclosure is not hindered. For example, a bracket is attached to the sheath 9 directly or via a rubber or the like.

As shown in FIG. 2, the shield cable 1 includes a first tape layer 11. In the orthogonal cross section, the first tape layer 11 is situated closer to the outer circumference of the shield cable 1 than the insulator 5 is. In the orthogonal cross section, the first tape layer 11 is situated between the insulator 5 and the shield 7. For example, the outer peripheral surface of the first tape layer 11 contacts the inner peripheral surface of the shield 7. For example, the inner peripheral surface of the first tape layer 11 contacts the outer peripheral surface of the insulator 5.

The first tape layer 11 includes a paper, a non-woven fabric, or a resin tape. The first tape layer 11 preferably includes no metals except for the inevitable impurities.

For example, the first tape layer 11 is formed by winding a band-shaped tape in a spiral manner. The tape is made of a paper, a non-woven fabric, or a resin tape. The resin tape is preferably made of foamed resin. For example, the foamed resin is preferably foamed polypropylene or foamed polyethylene. The winding direction of the first tape layer 11 is defined as follows.

A virtual point P is assumed on a tape included in the first tape layer 11 and moved along a longitudinal direction of the tape. At this time, the point P moves in the direction X of the longitudinal directions of the shield cable 1 as shown in FIG. 1. The point P is observed from a viewpoint A shown in FIG. 1. As shown in FIG. 2, the moving direction of the point P as viewed from the viewpoint A is the clockwise direction CW with the center of rotation being the central conductor 3, or the counter clockwise direction CCW with the center of rotation being the central conductor 3. The moving direction of the point P as viewed from the viewpoint A is the winding direction of the first tape layer 11.

It is preferable that the winding direction of the first tape layer 11 is opposite the twisting direction of the conductor strands of the central conductor 3. In the present embodiment, the twisting direction of the conductor strands of the central conductor 3 is the direction of the secondary-twist of the central conductor 3. The first tape layer 11 is preferably thinner than the shield 7.

The winding pitch of the first tape layer 11 is preferably two times or more and five times or less than the diameter of the insulator 5. The winding pitch of the first tape layer 11 is a distance in which the tape included in the first tape layer 11 advances in the longitudinal direction of the shield cable 1 when the tape is wound for one round.

As shown in FIG. 2, the shield cable 1 includes a second tape layer 13. In the orthogonal cross section, the second tape layer 13 is situated closer to the outer circumference of the shield cable 1 than the shield 7 is. In the orthogonal cross section, the second tape layer 13 is situated between the shield 7 and the sheath 9. For example, the inner peripheral surface of the second tape layer 13 contacts the outer peripheral surface of the shield 7. For example, the outer peripheral surface of the second tape layer 13 contacts the inner peripheral surface of the sheath 9.

The second tape layer 13 includes a paper, a non-woven fabric, or a resin tape. The second tape layer 13 preferably includes no metals except for the inevitable impurities. For example, the second tape layer 13 is formed by winding a band-shaped tape in a spiral manner. The tape is made of a paper, a non-woven fabric, or a resin tape. The resin tape is preferably made of foamed resin. For example, the foamed resin is preferably foamed polypropylene or foamed polyethylene.

For example, the second tape layer 13 is thinner than the shield 7. The tape of the second tape layer 13 is preferably the same as the tape of the first tape layer 11. In this case, a common tape can be used as the tape of the second tape layer 13 and the tape of the first tape layer 11.

The winding direction of the second tape layer 13 is defined as follows. A virtual point P is assumed on a tape included in the second tape layer 13 and moved along a longitudinal direction of the tape. At this time, the point P moves in the direction X of the longitudinal directions of the shield cable 1 as shown in FIG. 1. The point P is observed from a viewpoint A shown in FIG. 1. As shown in FIG. 2, the moving direction of the point P as viewed from the viewpoint A is the clockwise direction CW with the center of rotation being the central conductor 3, or the counter clockwise direction CCW with the center of rotation being the central conductor 3. The moving direction of the point P as viewed from the viewpoint A is the winding direction of the second tape layer 13.

It is preferable that the winding direction of the second tape layer 13 is opposite the twisting direction of the conductor strands of the central conductor 3. The winding direction of the second tape layer 13 is preferably the same as the winding direction of the first tape layer 11.

The second tape layer 13 is preferably thinner than the shield 7. The winding pitch of the second tape layer 13 is preferably two times or more and five times or less than the diameter of the insulator 5. The winding pitch of the second tape layer 13 is a distance in which the tape included in the second tape layer 13 advances in the longitudinal direction of the shield cable 1 when the tape is wound for one round.

### 2. Effects of Shield Cable 1

(1A) The shield cable 1 includes the first tape layer 11. The first tape layer 11 is situated between the insulator 5 and the shield 7. The first tape layer 11 includes a paper, a non-woven fabric, or a resin tape.

The first tape layer 11 inhibits the shield 7 from being damaged when the shield cable 1 is bent. The reason is inferred as follows. If the shield 7 is adhered to the insulator 5, a stress is applied to the shield 7 from the insulator 5 when the shield cable 1 is bent, which may damage the shield 7.

In a case where the first tape layer 11 is included, the shield 7 is not easily adhered to the insulator 5. Thus, when the shield cable 1 is bent, the shield 7 easily moves with respect to the insulator 5 in the longitudinal direction of the shield 7. As a consequence, a stress is not easily applied to the shield 7 from the insulator 5 when the shield cable 1 is bent; and therefore, the shield 7 is not easily damaged.
(1B) The shield cable 1 includes the second tape layer 13. The second tape layer 13 is situated between the sheath 9 and the shield 7. The second tape layer 13 includes a paper, a non-woven fabric, or a resin tape.

The second tape layer 13 inhibits the shield 7 from being damaged when the shield cable 1 is bent. The reason is inferred as follows. If the shield 7 is adhered to the sheath 9, a stress is applied to the shield 7 from the sheath 9 when the shield cable 1 is bent, which may damage the shield 7.

In a case where the second tape layer 13 is included, the shield 7 is not easily adhered to the sheath 9. Thus, when the shield cable 1 is bent, the shield 7 easily moves with respect to the sheath 9 in the longitudinal direction of the shield 7. As a consequence, a stress is not easily applied to the shield 7 from the sheath 9 when the shield cable 1 is bent; and therefore, the shield 7 is not easily damaged.
(1C) The twisting direction of the conductor strands of the central conductor 3 is opposite the winding direction of the first tape layer 11. Thus, torsion of the shield cable 1 generated from twisting the conductor strands of the central conductor 3 can be cancelled by torsion of the shield cable 1 generated from winding the first tape layer 11. As a consequence, torsion of the shield cable 1 can be reduced.

Furthermore, the twisting direction of the conductor strands of the central conductor 3 is opposite the winding direction of the second tape layer 13. Thus, torsion of the shield cable 1 generated from twisting the conductor strands of the central conductor 3 can be cancelled by torsion of the shield cable 1 generated from winding the second tape layer 13. As a consequence, torsion of the shield cable 1 can be further reduced.
(1D) The insulator 5 includes the specific mixture. The sheath 9 includes the specific mixture or ethylene propylene diene rubber. Thus, the shield cable 1 is excellent in heat resistance, flexibility, and bending durability at low temperatures. The bending durability at low temperatures is a property to resist damage from repeated bending in a low-temperature environment.

### Second Embodiment

### 1. Differences from First Embodiment

Since the basic configuration of the second embodiment is the same as the configuration of the first embodiment, differences will be explained hereinafter. If the reference numeral of an element or configuration is identical with that of the first embodiment, it means that the element or configuration is identical. In this case, reference should be made to the preceding description.

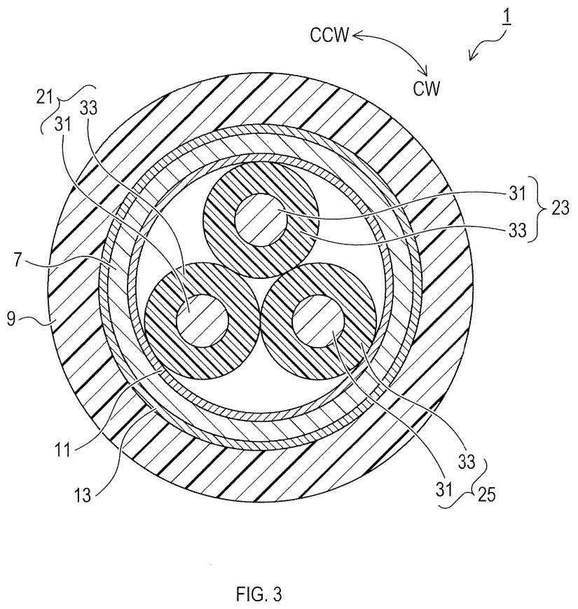

In the aforementioned first embodiment, the shield cable 1 includes one central conductor 3 and one insulator 5. Meanwhile, as shown in FIG. 3, the second embodiment is different from the first embodiment in that the shield cable 1 includes three electric wires 21, 23, and 25 which are twisted together.

The electric wires 21, 23, and 25 are twisted together. The twisting direction of the electric wires 21, 23, and 25 are defined as follows.

A virtual point P is assumed on any selected one of the electric wires 21, 23, or 25, and moved along a longitudinal direction of the selected electric wire. At this time, the point P moves in the direction X of the longitudinal directions of the shield cable 1 as shown in FIG. 1. The point P is observed from the viewpoint A shown in FIG. 1. As shown in FIG. 3, the moving direction of the point P as viewed from the viewpoint A is the clockwise direction CW with the center of rotation being the electric wires 21, 23, and 25, or the counter clockwise direction CCW with the center of rotation being the electric wires 21, 23, and 25. The moving direction of the point P as viewed from the viewpoint A is the twisting direction of the electric wires 21, 23, and 25.

The electric wire 21 includes a central conductor 31 and an insulator 33. The insulator 33 coats the central conductor 31. The central conductor 31 has the same configuration as that of the central conductor 3 in the first embodiment. The insulator 33 has the same configuration as that of the insulator 5 in the first embodiment. The electric wires 23 and 25 also have the same configuration as that of the electric wire 21.

In the orthogonal cross section, the first tape layer 11 is situated closer to the outer circumference of the shield cable 1 than the electric wires 21, 23, and 25 are. In the orthogonal cross section, the first tape layer 11 is situated between the shield 7 and the electric wires 21, 23, and 25. For example, the outer peripheral surface of the first tape layer 11 contacts the inner peripheral surface of the shield 7. For example, the inner peripheral surface of the first tape layer 11 contacts the outer peripheral surfaces of the insulators 33 of the electric wires 21, 23, and 25.

The winding direction of the first tape layer 11 is preferably opposite the twisting direction of the electric wires 21, 23, and 25. The winding direction of the second tape layer 13 is preferably opposite the twisting direction of the electric wires 21, 23, and 25.

### 2. Effects of Shield Cable 1

According to the second embodiment explained in detail above, the shield cable 1 exerts the aforementioned effects (1A), (1B), and (1D) of the first embodiment in addition to the following effects.
(2A) The twisting direction of the electric wires 21, 23, and 25 is opposite the winding direction of the first tape layer 11. Thus, torsion of the shield cable 1 generated from twisting the electric wires 21, 23, and 25 can be cancelled by torsion of the shield cable 1 generated from winding the first tape layer 11. As a consequence, torsion of the shield cable 1 can be reduced.

Furthermore, the twisting direction of the electric wires 21, 23, and 25 is opposite the winding direction of the second tape layer 13. Thus, torsion of the shield cable 1 generated from twisting the electric wires 21, 23, and 25 can be cancelled by torsion of the shield cable 1 generated from winding the second tape layer 13. As a consequence, torsion of the shield cable 1 can be further reduced.

### Other Embodiments

Although the embodiments of the present disclosure has been explained above, the present disclosure should not be limited to the aforementioned embodiments and may be implemented in various modifications.
(1) The shield cable 1 does not have to include one of the first tape layer 11 or the second tape layer 13 or both of the first tape layer 11 and the second tape layer 13.
(2) In the first and second embodiments, the winding direction of the first tape layer 11 may be opposite the winding direction of the second tape layer 13. In the first embodiment, the twisting direction of the conductor strands of the central conductor 3 may be the same as the winding direction of the first tape layer 11. The twisting direction of the conductor strands of the central conductor 3 may be the same as the winding direction of the second tape layer 13.

In the second embodiment, the twisting direction of the electric wires 21, 23, and 25 may be the same as the winding direction of the first tape layer 11. The twisting direction of the electric wires 21, 23, and 25 may be the same as the winding direction of the second tape layer 13.
(3) In the first and second embodiments, the tape of the first tape layer 11 and the tape of the second tape layer 13 do not have to be wound in a spiral manner. For example, the tapes may be longitudinally attached.
(4) In the second embodiment, the shield cable 1 includes three electric wires 21, 23, and 25. The number of the electric wire may be two, or four or more, for example.
(5) Functions of one element in the aforementioned embodiments may be distributed to two or more elements. Functions of two or more elements may be integrated into one element. A part of the configuration of the aforementioned embodiments may be omitted. At least a part of the configuration of the aforementioned embodiments may be added to or replaced with other configuration of the aforementioned embodiments.
(6) Other than the aforementioned shield cable 1, the present disclosure can also be implemented in various forms, such as a system including the shield cable 1 as an element, and a method of manufacturing the shield cable 1.

What is claimed is:

1. A shield cable comprising:
a central conductor;
an insulator situated closer to an outer circumference of the shield cable than the central conductor is;
a first tape layer situated closer to the outer circumference of the shield cable than the insulator is, the first tape layer being made of a paper, a non-woven fabric, or a resin tape;
a shield situated closer to the outer circumference of the shield cable than the first tape layer is;
a second tape layer situated closer to the outer circumference of the shield cable than the shield is, the second tape layer including a paper, a non-woven fabric, or a resin tape; and
a sheath situated closer to the outer circumference of the shield cable than the second tape layer is.

2. The shield cable according to claim 1,
wherein the central conductor includes conductor strands that are twisted together,
wherein the first tape layer and the second tape layer are each wound in a spiral manner, and
wherein a twisting direction of the conductor strands is opposite a winding direction of the first tape layer and a winding direction of the second tape layer.

3. A shield cable comprising:
electric wires twisted together;
a first tape layer situated closer to the outer circumference of the shield cable than the electric wires are, the first tape layer including a paper, a non-woven fabric, or a resin tape;
a shield situated closer to the outer circumference of the shield cable than the first tape layer is;
a second tape layer situated closer to the outer circumference of the shield cable than the shield is, the second tape layer including a paper, a non-woven fabric, or a resin tape; and
a sheath situated closer to the outer circumference of the shield cable than the second tape layer is.

4. The shield cable according to claim 3,
wherein the first tape layer and the second tape layer are each wound in a spiral manner, and
wherein a twisting direction of the electric wires is opposite a winding direction of the first tape layer and a winding direction of the second tape layer.
